(19) United States
(12) Patent Application Publication
(10) Pub. No.: US 2014/0135419 A1
(43) Pub. Date: May 15, 2014

(54) COMPOSITION FOR INKS AND COATINGS WITH HIGH LAMINATION BOND STRENGTH

(71) Applicant: BASF SE, Ludwigshafen (DE)

(72) Inventors: Cedric DU FRESNE VON HOHENESCHE, Frankenthal (DE); Bernd RECK, Gruenstadt (DE); Achim LOEFFLER, Speyer (DE); Steven ZIJLSTRA, Na Zwolle (NL); Arjan Thomas TERMATEN, GD Assen (NL)

(73) Assignee: BASF SE, Ludwigshafen (DE)

(21) Appl. No.: 14/071,797

(22) Filed: Nov. 5, 2013

Related U.S. Application Data
(60) Provisional application No. 61/724,309, filed on Nov. 9, 2012.

(51) Int. Cl. C09D 11/10; C09D 133/06

(52) U.S. Cl. CPC C09D 11/107; C09D 133/06
USPC 523/122; 525/176; 525/185; 524/377; 524/376; 525/93; 524/513; 524/502; 523/436; 523/437

(57) ABSTRACT

A composition obtained by the following steps (i) furnishing a composition (C) comprising an emulsion polymer (a) and thereafter (ii) adding to said composition (C) a composition comprising a water-soluble polymer (b) comprising ether groups, wherein said water-soluble polymer (b) does not comprise carboxylate groups and, said water-soluble polymer (b) has a solubility in water of at least 50 g/l. A method of making a such a composition and the use of such for water based coatings or inks is described.

A composition comprising (i) an emulsion polymer (a) comprising carboxylate groups, and (ii) a water-soluble random or block copolymer of ethylene oxide and propylene oxide having an ethylene oxide content of at least 45 weight-% with respect to the amount of the copolymer of ethylene oxide and propylene oxide and having a weight average molecular weight of from 300 to 4000 g/mol is also disclosed.

### FIELD OF THE INVENTION

The invention relates to a composition comprising emulsion polymers and water-soluble polymers with ether groups. Optionally, support resins with carboxylate groups may be comprised in the composition. Furthermore, the invention relates to a method of making such composition and to the use of such composition for water based coatings or inks. In particular, the invention relates to the use of such composition for water based inks for printing on plastic substrates and for water based coatings such as overprint varnishes or paints, especially as binders. Specifically, the invention relates to compositions useful for applications that require high lamination bond strength.

### BACKGROUND OF THE INVENTION

A variety of plastic films are used in the packaging industry for storage and shipping of goods. In many cases these plastic films are printed with text and images. Printing inks used for this purpose must meet certain end-use requirements for successful use in this application. These requirements include good printability, resolubility, resistance properties, and high lamination bond strength (LBS). Inks used with plastic packaging must also exhibit good wetting and flow properties and fast drying times.

Due to environmental and health concerns from solvent based inks, increased emphasis has been placed on the use of water-based inks for printing on films used for packaging in recent years. Water-based inks with good printability, i.e., good ink transfer and wetting, good adhesion to substrate and good image resolution are therefore highly desirable.

Similarly, water-based inks which have good resolubility, the ability of dry ink to redisperse in the same ink when in a wet state, are also important. If a press is stopped, for example, water-based inks begin to dry on the rollers and can undergo physical and chemical changes due to film formation, change in pH, and the like which render the printability of these inks problematic.

Finally, resistance of the printed or coated film to mechanical forces, water, solvents and other chemicals is also highly desirable. However, many water-based polymer coatings typically suffer from problems with adhesion, abrasion resistance, and water and solvent resistance.

Various polyvalent metal cross-linking agents have been used as additives to water-based coatings in an effort to improve the resistance properties of the coatings.

WO 2006/034229 A1 describes stable water-borne polymer compositions which comprise a water-borne polymer, a metal cross-linking agent and a stabilizing agent comprising from 2 to 10 carbon atoms and at least two functional groups independently selected from hydroxy and carboxy.

There is a need for water-based coatings, especially inks, which show, even without the use of metal cross-linking agents, good wetting, drying speed, flow behavior, printability, resistance properties, resolubility and good lamination bond strength when used for printing on plastic films and other substrates. Furthermore, such coatings must be stable upon storage and under normal conditions of use. Water-based inks and coatings of this invention exhibit these and other desirable properties when used on plastic films and other substrates.

In the current market solvent-based inks are often used. The binder types used in these solvent-based inks range from nitrocellulose/plasticizer to nitrocellulose/urethane combinations, and include polyvinylbutyrate, polyvinylchloride/urethane and polyurethanes. The transition to water based systems is slow due to a lack of water-based alternatives that offer good printability in combination with good LBS for applications such as printed oriented polypropylene (OPP) laminated to OPP or printed polyethyleneterephthalate (PET) laminated to low density polyethylene (LDPE).

A variety of water-based printing ink compositions is known from the state of the art.

WO 95/28436 A1 describes aqueous-based printing ink compositions adapted for use in gravure and flexographic printing on hydrophobic substrates which are prepared by combining a low-viscosity resin emulsion having an average particle diameter of less than about 0.5 microns and comprised of hydrophobic, moisture resistant, adherent resin forming components with a pigment paste containing a water-soluble polymer.

WO 97/19992 describes aqueous polymer emulsion compositions comprising a polymer. Also described therein are printing inks comprising a colorant and a binder for said colorant comprising such an aqueous emulsion polymer.

U.S. Pat. No. 5,284,894 describes latexes for use in printing inks and coatings for applications on a variety of substrates. These latexes are described to be suitable as vehicles for coating onto polyolefin surfaces.

U.S. Pat. No. 4,954,556 describes water-based ink compositions comprising emulsion polymers and rewetting agents.

Rheology Controlled (RC)-emulsions comprising emulsion polymers stabilized by alkali soluble resins comprising carboxylate groups (support resins) have been known as binders for aqueous printing inks with good resolubility and printability properties. Some limitations of these compositions become obvious when such inks are applied on typical flexible packing substrates like polyethylene (PE), polypropylene (PP) or PET.

Substrates with very specific and stringent requirements are laminated flexible packing materials, which are first printed e.g. on a transparent OPP or PET substrate and subsequently laminated with a second flexible substrate (film) such as OPP or PE, e.g. with a solvent free 2K PU (two component polyurethane) lamination adhesive. This application requires high lamination bond strengths, e.g. typically higher than 2.0 N/15 mm.

Generally, RC-emulsion based inks often show excellent printability but insufficient lamination bond strength (e.g. typically below 0.5 N/15 mm).

Therefore, it was one objective of the invention at hand to provide water-based inks or coatings that show high lamination bond strength.

Surprisingly it was found, that by combining compositions such as RC-emulsions with certain water-soluble polymers comprising ether groups, inks with good lamination bond strength can be obtained.

### SUMMARY OF THE INVENTION

In accordance with the present invention, there are provided compositions obtained by the following steps: (i) furnishing a composition (C) comprising an emulsion polymer (a), preferably comprising carboxylate groups, and thereafter (ii) adding to said composition (C) a composition comprising a water-soluble polymer (b) comprising ether groups, wherein said water-soluble polymer (b) does not comprise carboxylate groups and, said water-soluble polymer (b) has a solubility in water of at least 50 g/l.

In a preferred embodiment of the composition according to the invention the composition (C) further comprises a support resin (s) comprising carboxylate groups and said support resin (s) has an acid number in the range of from 10 to 400. In this case, more preferably, composition (C) corresponds to a RC-emulsion.

Upon curing, these compositions provide excellent lamination binding properties making them particularly suitable for use as binders in water-based inks for printing on plastic films and other substrates. The improved lamination binding strength of inventive compositions permit their use in a wide variety of applications including water-based inks, overprint varnishes, paints, adhesives, sealing lacquers, molding materials, barrier coatings, electronic materials such as resists, and the like.

In another aspect, the present invention provides methods of making and using the compositions described herein. Thus, for example, compositions may be prepared by combining an emulsion polymer comprising carboxylate groups with a water-soluble polymer comprising ether groups, for example by mixing aqueous solutions of these substances.

The compositions of the invention may be applied as a film or coating to a substrate such as paper, wood, plastic, or textiles. The compositions may be applied using curtain coating, flow coating or roll coating. When formulated as an ink, inventive compositions may be applied using gravure and flexographic printing processes including offset and screen printing processes.

### DETAILED DESCRIPTION OF THE INVENTION

In one aspect, the present invention provides compositions obtained by the following steps
(i) furnishing a composition (C) comprising an emulsion polymer (a), preferably comprising carboxylate groups, and thereafter
(ii) adding to said composition (C) a composition comprising a water-soluble polymer (b) comprising ether groups,
   wherein
   said water-soluble polymer (b) does not comprise carboxylate groups and,
   said water-soluble polymer (b) has a solubility in water of at least 50 g/l.

In a preferred embodiment of the composition according to the invention the composition (C) further comprises a support resin (s) comprising carboxylate groups and said support resin (s) has an acid number in the range of from 10 to 400. In this case, more preferably, composition (C) corresponds to a RC-emulsion.

Solubility in water is determined qualitatively by assessing a solution of a substance in water at 25° C. which should render a clear solution free of sediment. Solubility is thus determined by increasing the concentration of said substance in water until the solution is no longer clear and/or free of sediment.

In the framework of the invention at hand, the term “water-soluble” characterizing said water-soluble polymer (b) is understood as a water-soluble polymer (b) that has a solubility of at least 50 g/L in water at 25° C., preferably 100 g/L in water at 25° C. Most preferably the water-soluble polymer (b) is fully miscible with water.

In other embodiments, the emulsion polymer (a) can have an acid number preferably in the range from 10 to 300, more preferably from 15 to 200 and most preferably from 20 to 100. In a preferable embodiment, the emulsion polymer (a) has an acid number in the range from 40 to 100.

Acid numbers are determined according to methods well-known to a person skilled in the art by a potentiometric titration with 0.1 M KOH in water in a suitable solvent (aceton/water; 80/20). The results are reported as “mg KOH/g product”.

Support resins (s) that can be used in inventive compositions typically include polymers selected from the group of acrylics, vinyls (including but not limited to styrenics, polyvinyl alcohols, and polyvinyl acetates), acrylic/vinyls, polyurethanes, polyamides, polyesters, polyethylene glycols, styrene-butadiene-rubber (SBR) polymers, nitrocelluloses, hybrids thereof, or blends thereof.

Hybrid polymers are compositions containing more than one type of polymer and are made by sequential polymerization of one polymer in the presence of another. Hybrid polymers can include copolymers wherein the preparation of the second polymer in the presence of the first polymer results in the formation of copolymer. Hybrid polymers also include, but are not limited to random, alternating or block-copolymers.

In a preferred embodiment of the composition the support resin (s) comprises a water-soluble resin.

Preferably, the support resin (s) comprises an acrylic, acrylic/vinyl, polyester polymer, a hybrid thereof, or a blend thereof.

For example the acrylic support resin (s) comprises polymerized monomers selected from one or more of acrylic acid, methacrylic acid, itaconic acid, maleic acid, fumaric acid, crotonic acid, acrylic anhydride, methacrylic anhydride, itaconic anhydride, maleic anhydride, fumaric anhydride, crotonic anhydride, ethyl methacrylate, methyl methacrylate, butyl acrylate, butyl methacrylate, 2-ethylhexyl acrylate, ethyl acrylate, vinyl acetate, methyl acrylate, 2-hydroxyethyl methacrylate, 2-hydroxyethyl acrylate, methylol acrylamide, glycidyl acrylate, glycidyl methacrylate, diacetone acrylamide, acetoacetoxyethyl methacrylate, acetoacetoxyethyl acrylate, allyl acetoacetate, vinyl acetoacetate, acrolein, diacetone acrylate, acetonyl acrylate, diacetone methacrylate, 2-hydroxypropyl acrylate acetylacetate, butanediol-1,4-acrylate acetylacetate a hybrid thereof, or a blend thereof.

In another preferred embodiment the support resin (s) comprises an acrylic/styrenic polymer, and the support resin (s), in addition to the acrylic groups listed above, comprises polymerized monomers selected from one or more of styrene, methyl styrene, alpha-methyl styrene, ethyl styrene, isopropyl styrene, tertiary-butyl styrene, acyclic conjugated dienes, vinyl esters, vinyl chloride, formyl styrol, vinyl methyl ketone, vinyl ethyl ketone, vinyl butyl ketone, a hybrid thereof, or a blend thereof.

Vinyl/acrylic support polymers (s) such as styrene/acrylic polymers are particularly suitable for use in inventive compositions. Natural polymers are also contemplated for use in the present invention and include proteins, (hydroxyethyl)cellulose, cotton, starch and the like.

In another embodiment the support resin (s) further comprises a vinyl, polyurethane, polyamide, styrene-butadiene-rubber polymer, nitrocellulose, a hydrid thereof, or a blend thereof.

The skilled in the art will readily appreciate that the mixture of monomers may be varied as necessary to tailor the polymer to the particular application at hand. For example, support resins (s) used in inventive compositions can have a wide range of acid numbers as described above.

The dry weight of the polymers (a), (s) and (b) together may be adjusted according to the application and can make up anywhere from about 0.1 to about 95 weight percent (weight-%) of the composition. In other embodiments the weight of the polymers (a) and (b) constitutes from about 0.1 to about 70 weight-%, about 0.1 to about 60 weight-%, about 1 to about 50 weight-%, about 5 to about 50 weight-%, or about 10 to about 50 weight-% of the composition according to the invention.

The preparation of an emulsion polymer (a) comprising carboxylate groups is well known to those skilled in the art.

For example, the preparation of emulsion polymers is described in Emulsion Polymerization by Gilbert, R. G., Academic Press, N.Y., 1995, pp 1-23. The preparation of styrene/acrylic polymers is described in U.S. Pat. Nos. 4,546,160, 4,414,370, 4,529,787.

Generally such emulsion polymers are prepared with ethylenically unsaturated monomers, and initiators, and optionally with surfactants, alkali, and water or another reaction solvent. Exemplary monomers include but are not limited to acrylic acid, methacrylic acid, itaconic acid, maleic acid, fumaric acid, crotonic acid, acrylic anhydride, methacrylic anhydride, itaconic anhydride, maleic anhydride, fumaric anhydride, crotonic anhydride, styrene, methyl styrene, alpha-methyl styrene, ethyl styrene, isopropyl styrene, tertiarybutyl styrene, ethyl methacrylate, methyl methacrylate, butyl acrylate, butyl methacrylate, 2-ethylhexyl acrylate, ethyl acrylate, vinyl acetate, methyl acrylate, acyclic conjugated dienes, 2-hydroxyethyl methacrylate, 2-hydroxyethyl acrylate, methylol acrylamide, glycidyl acrylate, glycidyl methacrylate, vinyl esters, vinyl chloride, and the like.

Emulsion polymers suitable for use with the present invention include self-crosslinkable polymers (see, e.g., U.S. Pat. Nos. 5,432,229, 5,605,722, 6,355,720, and 6,538,062). Self-crosslinkable polymers comprise polymerized self-crosslinkable monomers such as diacetone acrylamide (DAAM), acetoacetoxyethyl methacrylate, acetoacetoxyethyl acrylate, allyl acetoacetate, vinyl acetoacetate, acrolein, formyl-styrol, vinyl methyl ketone, vinyl ethyl ketone, vinyl butyl ketone, diacetone acrylate, acetonyl acrylate, diacetone methacrylate, 2-hydroxypropyl acrylate acetylacetate, butanediol-1,4-acrylate acetylacetate, allyl methacrylate, and the like. Preferably emulsion polymers can be prepared in the presence of support resins.

In a preferred embodiment, the emulsion polymer (a) comprises polymerized monomers selected from one or more of acrylic acid, methacrylic acid, itaconic acid, maleic acid, fumaric acid, crotonic acid, acrylic anhydride, methacrylic anhydride, itaconic anhydride, maleic anhydride, fumaric anhydride, crotonic anhydride, ethyl methacrylate, methyl methacrylate, butyl acrylate, butyl methacrylate, 2-ethylhexyl acrylate, ethyl acrylate, vinyl acetate, methyl acrylate, 2-hydroxyethyl methacrylate, 2-hydroxyethyl acrylate, methylol acrylamide, glycidyl acrylate, glycidyl methacrylate, diacetone acrylamide, acetoacetoxyethyl methacrylate, acetoacetoxyethyl acrylate, allyl acetoacetate, vinyl acetoacetate, acrolein, diacetone acrylate, acetonyl acrylate, diacetone methacrylate, 2-hydroxypropyl acrylate acetylacetate, butanediol-1,4-acrylate acetylacetate a hybrid thereof, or a blend thereof.

The skilled in the art will readily appreciate that the mixture of monomers may be varied as necessary to tailor the polymer to the particular application at hand. For example, emulsion polymers (a) used in inventive compositions can have a wide range of acid numbers as described above.

The compositions (C) useful in the inventive compositions can also have a wide range of glass transition temperatures (Tg). For example polymers useful in this invention can have Tg values from −40 to 150° C., preferably from −40 to 40° C. Tg values are determined by Differential Scanning Microscopy (DSC).

Water-soluble polymers (b) that can be used in inventive compositions typically include polymers selected from the group of polyalkylene oxides, polyesterpolyols, hybrids thereof, or blends thereof.

Polyalkylene oxides are polymers based on monomers selected from the group of epoxides, preferably ethylene oxide, propylene oxide, 1,2-butylen oxide and 2,3-butylen oxide, more preferably ethylene oxide and propylene oxide.

In another embodiment the water-soluble polymer (b) of the inventive composition comprises ether groups derived from alkylene oxides, preferably ethylene oxide (EO), propylene oxide (PO), butylen oxide, more preferably ethylene oxide and/or propylene oxide.

In another embodiment the water-soluble polymer (b) of the inventive composition comprises a random or block alkylene oxide polymer.

The skilled in the art will readily appreciate that the mixture of monomers may be varied as necessary to tailor the polymer to the particular application at hand.

In yet another embodiment the water-soluble polymer (b) of the inventive composition comprises groups derived from alcohols, such as alcohols derived from natural oils like castor oil and other natural materials, oxoalcohols, alkylphenols.

In another embodiment the water-soluble polymer (b) of the inventive composition has a weight average molecular weight Mw in the range from 300 to 15000 g/mol, preferably from 350 to 10000 g/mol, most preferably from 400 to 8000 g/mol and particularly from 400 to 6000 g/mol. Mw values are determined by Gel Permeation Chromatography (GPC) using a Waters Alliance 2690 Separations Module equipped with a Waters 2414 Refractive Index detector at a concentration of around 10 mg/ml in THF solvent.

In another embodiment the water-soluble polymer (b) of the inventive composition does not comprise amine groups.

In yet another embodiment the water-soluble polymer (b) of the inventive composition does not comprise ester groups.

In a preferred embodiment the water-soluble polymer (b) of the inventive composition does comprise neither ester nor amine groups.

The preparation of water-soluble polymers (b) comprising ether groups is well known to those skilled in the art.

In general, in the inventive compositions the amount of emulsion polymer (a) is from 70 to 99 weight-% and the amount of water-soluble polymer (b) is from 1 to 30 weight-%, based on the total amount of emulsion polymer (a) and water-soluble polymer (b). Preferably the amount of emulsion polymer (a) is from 80 to 99 weight-% and the amount of water-soluble polymer (b) is from 1 to 20 weight-%, more preferably the amount of emulsion polymer (a) is from 85 to 99 weight-% and the amount of water-soluble polymer (b) is from 1 to 15 weight-%, and most preferably the amount of emulsion polymer (a) is from 90 to 99 weight-% and the amount of water-soluble polymer (b) is from 1 to 10 weight-%, based on the total amount of emulsion polymer and water-soluble polymer.

In a preferred embodiment the amount of emulsion polymer (a) and support resin (s) together is from 70 to 99 weight-% and the amount of water-soluble polymer (b) is from 1 to 30 weight-%, preferably the amount of emulsion polymer (a) and support resin (s) together is from 90 to 99 weight-% and the amount of water-soluble polymer (b) is from 1 to 10 weight-%, based on the total amount of emulsion polymer (a), support resin (s) and water-soluble polymer (b).

In general, in the inventive compositions the amount of emulsion polymer (a) is from 50 to 95 weight-% and the amount of support resin (s) is from 5 to 50 weight-%, based on the total amount of emulsion polymer(a) and support resin (s).

In a preferred embodiment of the inventive composition, the emulsion polymer (a) comprises polymerized monomers selected from one or more of acrylic acid, methacrylic acid, itaconic acid, maleic acid, fumaric acid, crotonic acid, acrylic anhydride, methacrylic anhydride, itaconic anhydride, maleic anhydride, fumaric anhydride, crotonic anhydride, ethyl methacrylate, methyl methacrylate, butyl acrylate, butyl methacrylate, 2-ethylhexyl acrylate, ethyl acrylate, vinyl acetate, methyl acrylate, 2-hydroxyethyl methacrylate, 2-hydroxyethyl acrylate, methylol acrylamide, glycidyl acrylate, glycidyl methacrylate, diacetone acrylamide, acetoacetoxyethyl methacrylate, acetoacetoxyethyl acrylate, allyl acetoacetate, vinyl acetoacetate, acrolein, diacetone acrylate, acetonyl acrylate, diacetone methacrylate, 2-hydroxypropyl acrylate acetylacetate, butanediol-1,4-acrylate acetylacetate a hybrid thereof, or a blend thereof,

and the support resin (s) comprises an acrylic, acrylic/vinyl, styrenic, acrylic/styrenic, polyester polymer,
and the water-soluble polymer (b) comprises polymerized monomers selected from the group of ethylene oxide, propylene oxide, 1,2-butylen oxide and 2,3-butylen oxide, preferably polymerized monomers selected from the group of ethylene oxide and propylene oxide.

Another ascpect of the invention is a composition comprising
(i) an emulsion polymer (a) comprising carboxylate groups, and
(ii) a water-soluble random or block copolymer of ethylene oxide and propylene oxide having an ethylene oxide content of at least 45 weight-% with respect to the amount of the copolymer of ethylene oxide and propylene oxide and having a weight average molecular weight of from 300 to 4000 g/mol, preferably from 350 to 3000 g/mol.

In one embodiment of the inventive composition, the composition further comprises one or more additives (c) selected from surfactants, solvents, leveling agents, rheology agents, waxes, buffering agents, dispersing agents, defoaming agents, antifoaming agents, modifying polymers, rewetting agents, biocides, crosslinking agents or resolubility agents.

In general, in the case that one or more additives (c) are present, in the inventive compositions the amount of emulsion polymer (a) is from 65 to 98.9 weight-% and the amount of water-soluble polymer (b) is from 1 to 30 weight-% and the amount of one or more additive (c) is from 0,1 to 5 weight-% based on the total amount of emulsion polymer (a), water-soluble polymer (b) and one or more additives (c).

In general, in the case that one or more additives (c) and support resin (s) are present, in the inventive compositions the amount of emulsion polymer (a) together with support resin (s) is from 65 to 98.9 weight-% and the amount of water-soluble polymer (b) is from 1 to 30 weight-% and the amount of one or more additive (c) is from 0.1 to 5 weight-% based on the total amount of emulsion polymer (a), support resin (s) water-soluble polymer (b) and one or more additives (c).

A wide range of surfactants are suitable for use including anionic, cationic, and nonionic. Typically, anionic surfactants include alkyl sulfonates, alkylaryl sulfonates, alkyl sulfates, sulfates of hydroxyalkanols, alkyl and alkylaryl disulfonates, sulfonated fatty acids, sulfates and sulfonates of polyethoxylated alkanols and alkylphenols as well as esters of sulfosuccinic acid.

Nonionic surfactants are particularly suitable for use with inventive compositions and include, e.g., polyvinylpyrrolidone, alkyl polysaccharides, and the like.

In another aspect of the invention, there are provided methods of making compositions as described herein comprising combining, e.g. mixing, the composition comprising emulsion polymer (a), preferably with the support resin (s), with the composition comprising the water-soluble polymer (b), preferably in the amounts described herein. The invention therefore also relates to a method of making the inventive composition comprising combining the emulsion polymer (a), preferably with the support resin (s), with the composition comprising the water-soluble polymer (b), the water-soluble polymer (b) and optionally one or more additives (c).

Preferably, combining an emulsion polymer (a) comprising carboxylate groups, preferably with the support resin (s), with a water-soluble polymer (b) comprising ether groups and optionally one or more additives (c) is carried out by mixing aqueous solutions of these substances.

In another embodiment water-soluble polymer (b) is added to an aqueous solution of emulsion polymer (a), preferably with the support resin (s), and optionally one or more additives (c) are added to the resulting composition.

In general, as long as an aqueous solution of emulsion polymer (a), preferably with the support resin (s), is furnished first and water-soluble polymer (b) and optionally one or more additives (c) are added later, the sequence of adding (b) and (c) is not relevant. Water-soluble polymer (b) and optionally one or more additives (c) may be added as (dry) substances or in aqueous solution.

The term “aqueous solution” of a substance also comprises dispersions and suspensions of the substance in water.

In other embodiments, the inventive compositions can additionally comprise polyvalent metal cross-linking agents as disclosed in WO 2006/034229 A1. The amount of metal crosslinking agents employed will vary depending upon the amount of emulsion polymer (a) and the acid number of the polymer. Suitable polyvalent metals include zirconium, titanium, hafnium, chromium, zinc, aluminum, or a mixture of any two or more thereof. Zirconium is especially well suited as a metal cross-linking agent. The metalcrosslinking agent is typically a salt or complex of ammonia, acetate, propionate, sulfate, carbonate, nitrate, phosphate, tartrate, acetylacetonate, oxide, or a mixture of any two or more thereof. Thus, exemplary metal crosslinking agents include ammonium zirconium carbonate, zirconium acetylacetonate, zirconium acetate, zirconium carbonate, zirconium sulfate, zirconium phosphate, potassium zirconium carbonate, zirconium sodium phosphate, zirconium tartrate, zinc oxide, and other combinations of the above polyvalent metals and counter ions. Similarly, organic titanates such as titanium acetylacetonate and titanium lactate chelate can be used. The amount of the optional metal cross-linking agent used in inventive compositions will vary with the nature of the polymer and polyvalent metal. The composition generally has a molar ratio of carboxylate groups to metal cross-linking agent of from about 10:1 to about 1:2, from about 9:1 to about 1:2, from about 8:1 to about 1:2, from about 7:1 to about 1:2, from about 6:1 to about 1:2, from about 5:1 to about 1:2, from about 4: 1 to about 1:2, from about 3:1 to about 1:2, from about 10:1 to about 1:1, from about 8:1 to about 1:1, from about 6:1 to about 1:1, from about 4:1 to about 1:1, or from about 3:1 to about 1:1.

In other embodiments, the inventive compositions can additionally comprise a wide variety of organic compounds as stabilizing agents so long as they contain at least two hydroxy or carboxy groups or one of each. It is to be understood that the stabilizing agents are not to be limited to two functional groups and may include additional hydroxy and carboxy groups as well as other functional groups such as oxo, amino, thiol, cyano, nitro, and the like if such groups do not interfere with the stabilizing ability of

the compound. While such compounds may contain from 2 to 10 carbon atoms, typically these compounds will have from 2 to 8 or 2 to 6 carbon atoms. Suitable stabilizing agents of the invention therefore include but are not limited to diols, hydroxy acids, diacids, sugars, or mixtures of two or more thereof. For example, a stabilizing agent can be tartaric acid, gluconic acid, mucic acid, saccharic acid, oxalic acid, glycolic acid, lactic acid, malic acid, citric acid, mandelic acid, malonic acid, maleic acid, succinic acid, a salt thereof, or a mixture of two or more thereof. Stabilizing agents which are sugars include mannitol, fructose, glucose, and mixtures of two or more thereof or mixtures with diols, hydroxy acids or diacids. The amount of stabilizing agent used in compositions of the invention is 1.4 mole percent or more of the amount of the cross-linking agent. In other embodiments, the amount of stabilizing agent can be 2.4 mole percent or more, 3 mole percent or more, or 7 or 10 mole percent or more of the amount of the cross-linking agent. Alternatively, the molar percentage of the stabilizing
agent of metal cross-linking agent is at least 1.4, 2.4, 3, 7, 8, 9, or 10 to about 40 mole percent or at least 1.4, 2.4, 3, 7, 8, 9, or 10 to about 30 mole percent or is at least 1.4, 2.4, 3, 7, 8, 9, or 10 to about 20 mole percent.

Upon drying, coating compositions of the invention display excellent strength and hardness and are especially useful as top coating agents for plastics, overprint varnishes, printing inks, paints, adhesives, fillers, molding materials, electronic materials such as resists, or the like. Thus, an overprint varnish, a paint or a heat seal lacquer may each independently include a composition as described herein. An ink may further include a pigment.

Compositions are further provided which include emulsion polymer (a), preferably comprising carboxylate groups, support resin (s) comprising carboxylate groups and a water-soluble polymer (b) comprising ether groups, wherein said support resin (s) has an acid number in the range from 10 to 400, preferably from 15 to 350, most preferably from 50 to 300, said water-soluble polymer (b) does not comprise carboxylate groups and, said water-soluble polymer (b) has a solubility in water of at least 50 g/l, wherein the amounts of emulsion-polymer (a), support resin (s) and water-soluble polymer (b) are sufficient to cause a coating, such as an ink, comprising the composition to display a larger LBS than the same coating without the water-soluble polymer (b) being added to a composition comprising an emulsion polymer (a), preferably comprising carboxylate groups and support resin (s) comprising carboxylate groups. Some such compositions can further include a pigment.

In yet another aspect of the invention, there are provided methods of preparing a film or coating comprising applying a composition as described herein as a film or coating to a substrate. Substrates may include paper, wood, plastic, or textiles. In particular, overprint varnishes and inks of the invention may be applied to paper and films or sheets of polyethylene, polyvinyl chloride, polypropylene, polyester, polycarbonate, and polyimide, and paper treated with any of these materials.

Methods for coating the substrate with the overprint varnish or ink of the invention include well-known methods such as direct coating and printing. For directly coating the substrate with over-print varnish or ink, such methods as curtain coating, flow coating and roll coating can be used. Where the composition is low in viscosity, direct coating such as spray coating can also be employed. Printing processes used for coating include offset printing, gravure offset printing, and gravure and flexographic printing processes. The thickness of the coating film produced by these processes can be about 0.25 to about 25 micrometers, typically, about 1 to about 10 micrometers.

Furthermore the invention also relates to the use of the inventive compositions for water based coatings or inks. Preferably to the use for water based inks for printing on substrates, preferably for printing on plastic films. Also preferably to the use of compositions according to the invention for water based coatings for overprint varnishes or paints.

Furthermore, the invention also relates to the use of compositions according to the invention for water based inks for laminating printed (primary) substrates to (secondary) flexible films. These laminates render high lamination bondstrengths of preferably >1.5 N/15 mm and most preferably >2 N/15 mm before and after heatseal.

Lamination is carried out by procedures well known to a person skilled in the art. Laminates in general are obtained for example by applying the composition according to the invention or an ink-formulation of said composition to the surface of a plastic substrate. After drying a coated substrate is obtained. Subsequently a lamination adhesive is used to fix a second plastic surface to the coated substrate.

Typical Ink Preparation:

Coloured ink is prepared by blending 30 parts of a (resin-based or resin-free) pigment paste (e.g. PB15.3) and 70 parts of a test emulsion. The viscosity of the ink can be measured employing a DIN4 cup. The viscosity of the ink can be reduced to 20 s DIN4 using a 30/70 blend of pigment paste/water.

White ink is prepared by blending 40 parts of a resin-free pigment paste (e.g. PW6) and 60 parts of a test emulsion. The viscosity of the ink can be measured employing a DIN4 cup. The viscosity of the ink can be reduced to 20 s DIN4 using a 40/60 blend of pigment paste/water.

Typical Ink Application:

Ink was applied on the treated side of coex-OPP (30MB400—Oriented Polypropylene Film which can be obtained from ExxonMobil Chemical) and on chemically treated polyester (Mylar® 813 which can be obtained from DuPont Teijin Films), using a wire-bar 0 (4 μm wet ink). Inks were applied as 100% colour (1 layer), 200% colour (2 layers) and 100% colour plus 100% white (2 layers). The resulting prints were dried in an oven for 60 s at 60° C. followed by a further drying period of about 16 hours (overnight) at room temperature, before making a laminate

Typical Lamination Procedure:

In order to test the lamination bondstrengths, the prints on coex-OPP and chemically treated polyester were laminated to coex-OPP and standard LDPE (Low-density Polyethylene), respectively to give OPP//OPP and PET//LDPE laminates.
1. Preparation of the 2 component polyurethane lamination adhesive:
Liofol Hardener UR6080: 8.0 (obtained from Henkel Industrial Adhesives)
Liofol UR7780: 20.0 (obtained from Henkel Industrial Adhesives)
Ethyl acetate: 20.0 (solvent for ease of application)
   2. Preparation of the Laminate:

The freshly prepared adhesive is applied to the secondary (unprinted) film at a coating weight of 2.5 g/m² (dry), and subsequently dried in the oven for 10 s at 60° C. to evaporate the solvent. The printed film is next carefully applied with the printed side to the adhesive print, thereby avoiding creation of air bubbles in the laminate. The resulting laminates are stored for 3 days under pressure, in order to allow the adhesive to cure.
3. Bond Strength Measurement:

A strip of 15 mm width is cut from the cured laminate and lamination bond strength is measured using a Lloyd Instruments tensile tester (which can be purchased from AMETEK, Inc.). Measurement is done at a speed of 150 mm/min. During the measurement, the laminated strip should be kept under a 90° angle against the film clamps.

This test is repeated after the laminated strip has been heat-sealed at 140° C./400N/1 s using a Brugger heat sealer (which can be purchased from Brugger Feinmechanik GmbH), in order to simulate heat-seal bond strength.

Lamination bond strength is reported in N/15 mm.

As will be understood by one skilled in the art, for any and all purposes, particularly in terms of providing a written description, all ranges disclosed herein also encompass any and all possible sub ranges and combinations of sub ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above.

All patents and publications described herein are incorporated by reference in their entirety for all purposes.

### EXAMPLES

The following non-limiting examples serve to further illustrate advantages of the disclosed invention.

### Example 1

### Providing Support Resins (s)

The support resin compositions given in Table 1 were prepared using a continuous polymerization process described in U.S. Pat. Nos. 4,546,160, 4,414,370, 4,529,787.

TABLE 1
Support Resins

| | Resin A | Resin B |
|---|---|---|
| Component | | |
| Acrylic acid [%] | 34.4 | 33.6 |
| Alpha-Methyl Styrene [%] | 31.5 | 35.6 |
| Styrene [%] | 34.1 | 25 |
| 2-Ethyl Hexylacrylate [%] | | 5.8 |
| Total | 100.0 | 100.0 |
| Process conditions | | |
| Reactor Temperature [° C.] | 212 | 217 |
| Residence Time [min] | 12 | 12 |
| Properties | | |
| MW (GPC) [g/mol] | 10000 | 9000 |
| MN (GPC) [g/mol] | 3200 | 3000 |
| Acid Number (mg KOH/g) | 215 | 220 |
| Oxygen Content | 14.8 | 15.1 |
| Tg [° C.] (Fox) | 123 | 117 |

Amounts of Components are given in weight-% relative to the total amount of Components.

### Example 2

### Emulsion Polymerization to Obtain Emulsion Polymer (a) in Presence of Support Resin (s)

Emulsion polymers given in Table 2 were prepared from the support resins given in Table 1. A solution of support resin, ammonia (25%) and de-ionized (DI) water was brought to 85° C. in a 4-neck round bottom flask under a mild flow of nitrogen. A mixture of monomers was prepared and charged to the reactor. Next, ammonium persulfate (APS) dissolved in DI water was charged to the reactor. After 15 minutes, the remaining monomer mixture was charged to the reactor over 45-60 minutes. During the process, temperature remained at 85° C. After this, the reactor content was kept under these conditions for 60 minutes to reduce residual monomer content. After this hold-period, the emulsion was cooled. The emulsion was mixed for an additional 15 minutes and subsequently filtered.

TABLE 2

| Name | E-1 | E-2 | E-3 |
|---|---|---|---|
| Resin A | 0 | 118 | 0 |
| Resin B | 145.8 | 0 | 99.5 |
| Ammonia 25% | 35.4 | 34.6 | 29 |
| DI Water | 514.3 | 487 | 538.3 |
| Methyl Methacrylate (MMA) | 59.8 | 75.4 | 65 |
| Methacrylic Acid (MAA) | 1.8 | 0 | 0 |
| n-Butyl Acrylate (n-BA) | 119.7 | 171.9 | 260 |
| 2-Ethylhexyl Acrylate (2-EHA) | 119.7 | 110.2 | 0 |
| Iso-octylmercaptopropionate (IOMPA) | | | 2 |
| Ammonium Persulfate (APS) | 3.5 | 2.9 | 1.75 |
| Trigonox AW70 | | | 2.5 |
| Sodium Erythorbate (s) | | | 2 |
| Total (g) | 1000 | 1000 | 1000 |

Trigonox AW70: 2-hydroperoxy-2-methylpropane

### Example 3

### Preparation of Polymer Blends

Blends of the described emulsion polymers (E-1, E-2, E-3) described in table 2 and water soluble polymers (P-1, P-2, P-3, P-4, P-5) described in table 3 were prepared by physical blending at room temperature. The selected formulations are given in Table 4.

TABLE 3
Water soluble polymers (b)

| Polymer | Copolymer Composition | EO % | MW |
|---|---|---|---|
| P-1 | glycerine based aliphatic polyesterpolyol | 70 | 400 |
| P-2 | alkyl-EO-PO random copolymer | 50 | 2000 |
| P-3 | polyethyleneglycol | 100 | 400 |
| P-4 | C16/C18 fatty alcohol ethoxylate | 50 | 2500 |
| P-5 | EO-PO-EO block copolymer | 50 | 1900 |

The amount of EO (ethylene oxide) is given in weight-% relative to the total amount of the copolymer. PO stands for propylene oxide.

TABLE 4
Polymer Blends

| Component | Code | B-1 | B-2 | B-3 | B-4 | B-5 | B-6 | B-7 | B-8 | B-9 | B-10 | B-11 |
|---|---|---|---|---|---|---|---|---|---|---|---|---|
| Emulsions | E-1 | 90 | | | | | | | | | | |
| | E-2 | | 90 | | | | | | | | | |
| | E-3 | | | 90 | 90 | 90 | 90 | 90 | 100 | 95 | 85 | 80 |
| Water sol. | P-1 | 10 | 10 | 10 | | | | | | | | |
| polymers | | | | | | | | | | | | |
| | P-2 | | | | 10 | | | | | | | |
| | P-3 | | | | | 10 | | | | | | |
| | P-4 | | | | | | 10 | | | | | |
| | P-5 | | | | | | | 10 | 0 | 5 | 15 | 20 |
| Total (%) | | 100 | 100 | 100 | 100 | 100 | 100 | 100 | 100 | 100 | 100 | 100 |

Amounts of Components are given in weight-% relative to the total amount of Components.

### Example 4

### Preparation of Lamination Inks

In order to test the effect on lamination bond strength, ink formulations were prepared by blending of the selected polymer blends (B-1-B-11) described in Table 4 with a pigment concentrate comprising PB15.3 (Heliogen® Blue D 7088) and Joncryl® HPD96-E (high molecular weight, high acid value styrene acrylic resin), both obtained from BASF S.E., in a 4:1 ratio. The viscosity of the resulting ink was adjusted to required print viscosity (20″ DIN4/˜150 mPa·s) by addition of a mixture of pigment concentrate and water (30/70).

TABLE 5
Ink formulations

| Component | Code | I-1 | I-2 | I-3 | I-4 | I-5 | I-6 | I-7 | I-8 | I-9 | I-10 | I-11 |
|---|---|---|---|---|---|---|---|---|---|---|---|---|
| Polymer Blend | B-1 | 70 | | | | | | | | | | |
| | B-2 | | 70 | | | | | | | | | |
| | B-3 | | | 70 | | | | | | | | |
| | B-4 | | | | 70 | | | | | | | |
| | B-5 | | | | | 70 | | | | | | |
| | B-6 | | | | | | 70 | | | | | |
| | B-7 | | | | | | | 70 | | | | |
| | B-8 | | | | | | | | 70 | | | |
| | B-9 | | | | | | | | | 70 | | |
| | B-10 | | | | | | | | | | 70 | |
| | B-11 | | | | | | | | | | | 70 |
| Pigment Concentrate | | 30 | 30 | 30 | 30 | 30 | 30 | 30 | 30 | 30 | 30 | 30 |
| Total (%) | | 100 | 100 | 100 | 100 | 100 | 100 | 100 | 100 | 100 | 100 | 100 |
| Viscosity (mPa · s) | | 250 | 290 | 140 | 450 | 150 | 2900 | 300 | 205 | 155 | 125 | 115 |
| Pigment Concentrate/Water (%) | | 4 | 6 | 0 | 11 | 0 | 26 | 7.5 | 2 | 0 | 0 | 0 |
| Final Viscosity (mPa · s) | | 145 | 120 | 140 | 155 | 150 | 150 | 145 | 140 | 155 | 125 | 115 |

Amounts of Components are given in weight-% relative to the total amount of Components.

### Example 5

### Preparation of Laminates and Bond Strength Measurement

The resulting inks were applied on the treated side of coex-OPP (30MB400) and on chemically treated polyester (Mylar 813) using a wire-bar 0 (4 μm wet ink). The prints were dried in an oven for 60 s at 60° C. and left overnight (16 hours).

Laminates were prepared by application of freshly prepared 2 component Polyurethane adhesive (8.0 g Liofol UR6080, 20.0 g Liofol UR7780, 20.0 g Ethylacetate) to a secondary (unprinted) film rendering a coating weight of 2.5 g/m² dry, followed by drying in the oven for 10 s at 60° C. The printed films (coex-OPP and chemically treated PET) are applied with the printed side to the adhesive side of the secondary films (coex-OPP and LDPE, respectively) to give OPP//OPP and PET//LDPE laminate structures. The laminate structures were stored for 3 days under pressure (ca 0.25 kg/cm²) to allow full cure of the adhesive.

For measurement of lamination bond strengths, a strip of 15 mm width is cut from the cured laminate and bond strength is measured using a Lloyd Instruments tensile tester (which can be purchased from AMETEK, Inc.). Measurement is done at a speed of 150 mm/min. During the measurement, the laminated strip should be kept under a 90° angle against the film clamps.

This test is repeated after the laminated strip has been heat-sealed at 140° C./400N/1 s using a Brugger heat sealer (which can be purchased from Brugger Feinmechanik GmbH), in order to simulate heat-seal bond strength.

Lamination bond strength is reported in N/15 mm.

TABLE 6
Lamination bond strength results

| Measurement | I-1 | I-2 | I-3 | I-4 | I-5 | I-6 | I-7 | I-8 | I-9 | I-10 | I-11 |
|---|---|---|---|---|---|---|---|---|---|---|---|
| OPP//OPP | 1.7 | 1.5 | 1.5 | 2.2 | 1.4 | 2.5 | 2.1 | 1.0 | 2.1 | 0.9 | 0.6 |
| OPP//OPP + | 1.9 | 1.6 | 1.3 | 2.0 | 1.5 | 3.0 | 2.1 | 0.7 | 2.2 | 1.1 | 0.9 |
| heatseal | | | | | | | | | | | |
| PET//LDPE | 1.7 | 2.0 | 2.4 | 2.5 | 1.7 | 2.4 | 2.7 | 0.6 | 2.3 | 1.5 | 1.5 |
| PET//LDPE + | 2.0 | 2.1 | 2.2 | 2.2 | 1.2 | 2.2 | 2.5 | 0.3 | 2.3 | 1.7 | 1.5 |
| heatseal | | | | | | | | | | | |

Compositions according to the invention including a water soluble polymer show improved results of lamination bond strength compared to compositions without water soluble polymers (I-8).

1. A composition produced by a process comprising:
adding to a first composition, comprising an emulsion polymer, a second composition comprising a water-soluble polymer comprising an ether group,
wherein the water-soluble polymer does not comprise a carboxylate group and,
the water-soluble polymer has a solubility in water of at least 50 g/l.

2. The composition according to claim 1,
wherein the first composition further comprises:
a support resin comprising a carboxylate group, and
the support resin has an acid number of from 10 to 400.

3. The composition according to claim 1,
wherein the water-soluble polymer comprises an ether group derived from an alkylene oxide.

4. The composition according to claim 1,
wherein the water-soluble polymer comprises a random or block alkylene oxide polymer.

5. The composition according to claim 1,
wherein the emulsion polymer comprises at least one polymerized monomer selected from the group consisting of acrylic acid, methacrylic acid, itaconic acid, maleic acid, fumaric acid, crotonic acid, acrylic anhydride, methacrylic anhydride, itaconic anhydride, maleic anhydride, fumaric anhydride, crotonic anhydride, ethyl methacrylate, methyl methacrylate, butyl acrylate, butyl methacrylate, 2-ethylhexyl acrylate, ethyl acrylate, vinyl acetate, methyl acrylate, 2-hydroxyethyl methacrylate, 2-hydroxyethyl acrylate, methylol acrylamide, glycidyl acrylate, glycidyl methacrylate, diacetone acrylamide, acetoacetoxyethyl methacrylate, acetoacetoxyethyl acrylate, allyl acetoacetate, vinyl acetoacetate, acrolein, diacetone acrylate, acetonyl acrylate, diacetone methacrylate, 2-hydroxypropyl acrylate acetylacetate, and butanediol-1,4-acrylate acetylacetate.

6. The composition according to claim 2,
wherein the support resin comprises a water-soluble resin.

7. The composition according to claim 2, wherein the support resin comprises an acrylic, acrylic/vinyl, or polyester polymer.

8. The composition according to claim 2, wherein the support resin comprises an acrylic/styrenic copolymer.

9. The composition according to claim 1, further comprising: at least one additive selected from the group consisting of a surfactant, a solvent, a leveling agent, a rheology agent, a wax, a buffering agent, a dispersing agent, a defoaming agent, an antifoaming agent, a modifying polymer, a rewetting agent, a biocide, a crosslinking agent, and a resolubility agent.

10. A method of producing the composition according to claim 1, the method comprising:
combining the first composition and optionally a support resin with the second composition and optionally one or more additives.

11. A water based coating, comprising:
the composition according to claim 1.

12. A water based ink, comprising:
the composition according to claim 1.

13. The water based coating according to claim 11,
wherein the water based coating is suitable for an overprint varnishes vanish or paints paint.

14. The water based ink according to claim 12,
wherein the water based ink is suitable for laminating a printed substrate to a secondary flexible film.

15. A composition comprising:
(i) an emulsion polymer comprising a carboxylate group, and
(ii) a water-soluble random or block copolymer of ethylene oxide and propylene oxide having an ethylene oxide content of at least 45 weight-% with respect to an amount of a copolymer of ethylene oxide and propylene oxide and having a weight average molecular weight of from 300 to 4000 g/mol.

16. An ink, comprising:
the composition according to claim 1.

17. The water based ink according to claim 12,
wherein the water based ink is suitable for printing on a substrate.

18. The water based ink according to claim 12,
wherein the water based ink is suitable for printing on a plastic film.
